(19) United States
(12) Patent Application Publication
(10) Pub. No.: US 2014/0109735 A1
(43) Pub. Date: Apr. 24, 2014

(54) SHAVING RAZORS

(71) Applicant: Ian Raymond SHEPPERSON, West Midlands (GB)

(72) Inventor: Ian Raymond SHEPPERSON, West Midlands (GB)

(21) Appl. No.: 13/655,721

(22) Filed: Oct. 19, 2012

(51) Int. Cl. B26B 21/52

(52) U.S. Cl. CPC B26B 21/521
USPC 83/13; 30/527; 30/532

(57) ABSTRACT

A shaving razor (10) includes a handle (11), a head part (14) and a first mounting (20) for mounting a blade holder (16) and/or a blade (18) to the head part (14). The handle (11) includes a body (12) for gripping by a user in use. The razor (10) includes a second mounting (34). The blade holder (16) and/or the blade (18) extend lengthwise along a first axis (26). The second mounting (34) is arranged to permit the blade holder (16) and/or the blade (18) to move pivotally in use relative to the body (12) around a second axis (52) which is orientated differently to the first axis (26).

### CROSS-REFERENCE TO RELATED APPLICATIONS

This application is a Continuation-In-Part (CIP) of International PCT Application PCT/GB2011/000624 filed on Apr. 21, 2011 which designates the U.S., and which claims priority from GB Application Nos. 1006829.4 filed Apr. 23, 2010 and 1017484.5 filed Oct. 15, 2010, all of which are herein incorporated by reference thereto.

This application also claims the benefit of GB Application No. 1118185.6 filed Oct. 21, 2011, the contents of which are incorporated herein by reference thereto.

### BACKGROUND OF THE INVENTION

1. Field of the Invention

The present invention relates to shaving razors.

2. the Prior Art

Conventionally, shaving razors are used to remove unwanted, relatively short hair from the body of a person or animal. A traditional razor comprises a sharp thin blade, typically of metal, which is scraped across the surface of the skin to remove hair growing out of the skin. The blade is usually mounted in a holder, and, commonly, both the blade and the holder are disposable. The holder is mounted to a handle for ease of gripping, and may be rigidly mounted, or may be mounted pivotally to the handle, so that the holder pivots in one plane relative to the handle, permitting the holder to move in use to accommodate contours of the skin and so give a more comfortable shave.

### SUMMARY OF THE INVENTION

According to a first aspect of the present invention there is provided a shaving razor, the razor including a handle and a head part, a first mounting for mounting a blade holder and/or a blade to the head part, the handle including a body for gripping by a user in use, the razor including a second mounting, wherein, in use, the blade holder and/or the blade extend lengthwise along a first axis, the second mounting being arranged to permit the blade holder and/or the blade to move pivotally relative to the body around a second axis which is orientated differently to the first axis.

Possibly, the second axis is substantially at 90° to the first axis.

Possibly, the body is elongate and has a longitudinal axis. Possibly, the head part is elongate and has a longitudinal axis. The body axis may be aligned or parallel with the head part axis.

Possibly, the second axis is substantially aligned along or parallel to the body axis and/or the head part axis.

Possibly, the first mounting is arranged to permit pivotal movement of the blade holder or blade about the first axis. Possibly, the blade holder includes a blade which has a cutting edge, and the first axis may be substantially parallel with the cutting edge. Possibly, the first axis is substantially at 90° to the body axis and/or the head part axis.

Possibly, the second mounting is arranged to permit pivotal movement of the head part about the second axis.

Possibly, the second mounting includes one or more limits to limit the movement of the blade holder and/or the blade relative to the body.

The second mounting may include a guide, which may guide movement of the blade holder and/or the blade relative to the body.

Possibly, the second mounting includes biasing means to bias the blade holder and/or the blade to a neutral condition. Possibly, the biasing means include one or more resiliently deformable members, which may be arranged to resist movement of the blade holder and/or the blade away from the neutral condition, and may be arranged to provide increasing resistance to further movement away from the neutral condition.

The, or each, resiliently deformable member may comprise a finger.

Possibly, the second mounting is arranged so that the deformation of the resiliently deformable member(s) is directly proportional to the amount of rotational movement of the blade holder and/or the blade away from the neutral condition. The or each resiliently deformable member may be deformed by torsion, and may comprise a torsion member which may comprise a collar, sleeve or pin.

The razor may comprise the blade holder and/or the blade.

In one embodiment, the head part comprises part of the handle. The first mounting may permit attachment and detachment of the blade holder and/or the blade from the head part. The second mounting may mount the head part to the body, and may mount the head part to the body so that detachment of the head part form the body is substantially prevented. The head part and the body may form an integral unit. The blade holder and/or the blade may be disposable.

Possibly, the second mounting includes a mounting member, which may extend between the head part and the body, and may project from the head part. The mounting member may be receivable within a passage, which may be defined by the body. The body may include means for retaining the mounting member within the passage.

In another embodiment, the head part comprises part of a head, which also comprises a fixed head part. The second mounting may mount the head part to the fixed head part. The second mounting may mount the head part to the fixed head part so that detachment of the head part from the fixed head part is substantially prevented.

The razor may include a third mounting which mounts the head to the body. The third mounting may permit attachment and detachment of the head from the body. The third mounting may be arranged so that the orientation of the fixed head part is fixed relative to the body. The head and the blade holder and/or the blade may comprise a head assembly, which in use may form an integral unit. The head assembly may be disposable.

Possibly, the second mounting is arranged to permit lateral movement of the head part relative to the body in any radial direction relative to the second axis. The second mounting may include a ball and socket arrangement, or may include a spring.

### BRIEF DESCRIPTION OF THE DRAWINGS

Embodiments of the present invention will now be described, by way of example only, and with reference to the accompanying drawings in which:

FIG. 1 is a perspective view of a first shaving razor, with a handle and a blade holder shown in a detached condition;

FIG. 2 is a perspective view of the handle of FIG. 1 in a partially disassembled condition;

FIG. 3 is an enlarged detail of the encircled part of the handle shown in FIG. 2 and labelled “III”;

FIG. 4 is a plan view of the handle;

FIG. 5 is a cross-sectional view from the side of the handle as indicated by the line marked V-V in FIG. 4;

FIG. 6 is a cross-sectional view from the side of the handle as indicated by the line marked VI-VI in FIG. 4;

FIG. 7 is a perspective view of the handle in use in a rotated condition;

FIG. 8 is an end view of the handle in the rotated condition of FIG. 7;

FIG. 9 is a perspective view of a second handle for a second shaving razor;

FIG. 10 is a perspective view of the handle of FIG. 9 in a partially disassembled condition;

FIG. 11 is a cross-sectional view from the side along the longitudinal axis of the handle of FIG. 9;

FIG. 12 is a perspective view of a third handle for a third shaving razor;

FIG. 13 is another perspective view of the handle of FIG. 12;

FIG. 14 is a plan view of a fourth handle;

FIG. 15 is a cross-sectional view from the side of the handle as indicated by the line marked XV-XV in FIG. 14;

FIG. 16 is a cross-sectional view from the end of the handle as indicated by the line marked XVI-XVI in FIG. 15;

FIG. 17 is a perspective view of a fifth handle in a partially disassembled condition;

FIG. 18 is a cross-sectional view from the side along the longitudinal axis of the handle of FIG. 17;

FIG. 19 is a plan view of a sixth handle;

FIG. 20 is a cross-sectional plan view along the longitudinal axis of the handle of FIG. 19;

FIG. 21 is a cross-sectional view from the end of the handle as indicated by the line marked XXI-XXI in FIG. 20;

FIG. 22 is a perspective view of a seventh handle;

FIG. 23 is a part cut away perspective view of an eighth razor;

FIG. 24 is a side sectional view of a head assembly of the eighth razor;

FIG. 25 is a part cut away perspective view of a head assembly of a ninth razor;

FIG. 26 is a side sectional view of the head assembly of the ninth razor;

FIG. 27 is a part cut away perspective view of a head assembly of a tenth razor;

FIGS. 28A and 28B are transverse cross sectional views of the head assembly of the tenth razor along line C-C of FIG. 27 in a neutral condition and a rotated condition respectively;

FIGS. 29A, 29B and 29C are perspective views of a head assembly of an eleventh razor in a neutral condition and first and second rotated conditions respectively;

FIG. 30 is a part cut away perspective view of a head assembly of a twelfth razor;

FIGS. 31A, 31B and 31C are perspective views of a head assembly of the twelfth razor in a first rotated condition, a neutral condition and a second rotated condition respectively;

FIGS. 32A, 32B and 32C are, respectively, a perspective view, a cross-sectional perspective view and a side view of a thirteenth razor;

FIGS. 33A, 33B and 33C are, respectively, a perspective view, a cross-sectional perspective view and a side view of a fourteenth razor; and

FIGS. 34A, 34B and 34C are, respectively, a perspective view, an exploded perspective view and another exploded perspective view of a fifteenth razor.

### DETAILED DESCRIPTION OF THE PREFERRED EMBODIMENTS

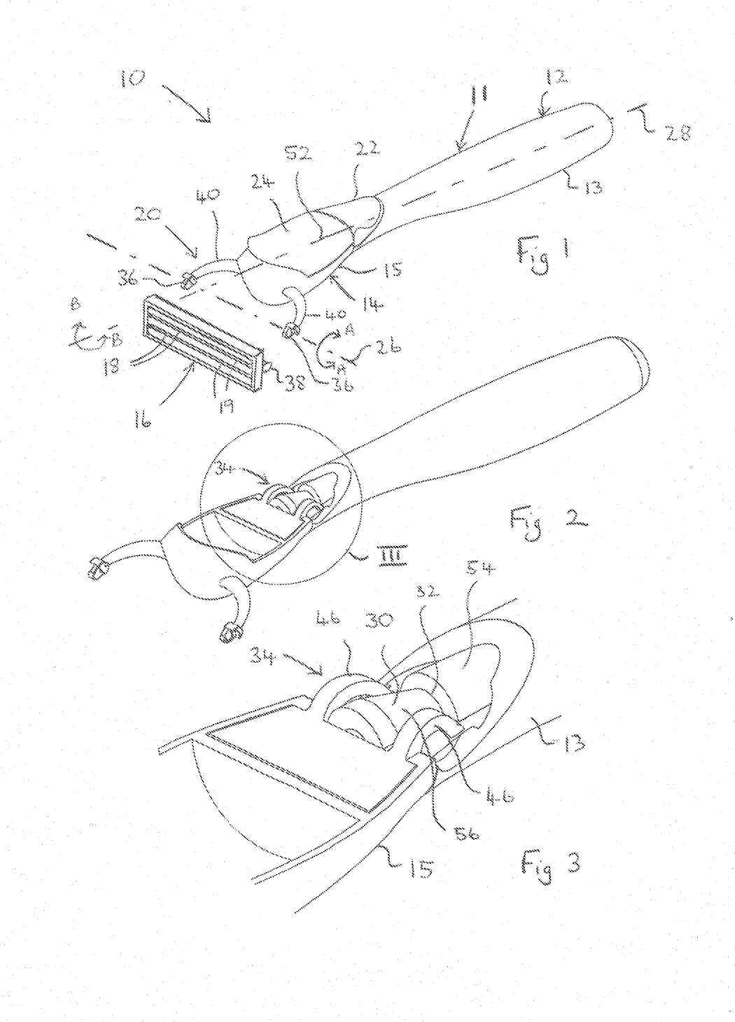

FIG. 1 shows a shaving razor 10 including a handle 11 and a blade holder 16, which is shown in a detached condition.

The handle 11 includes a head part 14, a first mounting 20 for mounting a blade holder 16 to the head part 14, a body 12 for gripping by a user in use, and a second mounting 34 for mounting the head part 14 to the body 12, the second mounting 34 being arranged to permit the head part 14 to move relative to the body 12.

The body 12 is elongate and has a longitudinal axis 28.

The head part 14 includes a main part 15 and a cover 24. The body 12 includes a main part 13 and a cover 22. In FIGS. 2 and 3, the covers 22, 24 have been removed to show the second mounting 34. The covers 22, 24 could be removable in use, or could be fixed in position on initial assembly of the handle 11.

The first mounting 20 is arranged to permit pivotal movement of the blade holder 16 about a first axis 26 as indicated by arrows A in FIG. 1. In this embodiment, the blade holder 16 includes a pair of blades 18, each of which has a cutting edge 19. The first axis 26 is substantially parallel with the cutting edges 19, and is substantially at 90° to the longitudinal body axis 28.

The first mounting 20 includes a pair of yoke arms 40, which extend outwardly from the main head part 15. A mounting formation 36 is located at the free end of each of the yoke arms 40. The mounting formations 36 are engageable with corresponding formations 38 projecting from the holder 16 to pivotally mount the holder 16 to the handle 11. The holder formations 38 are in the form of clips which removably push fit on to the mounting formations 38, to permit easy removal and replacement of the blade holder 16.

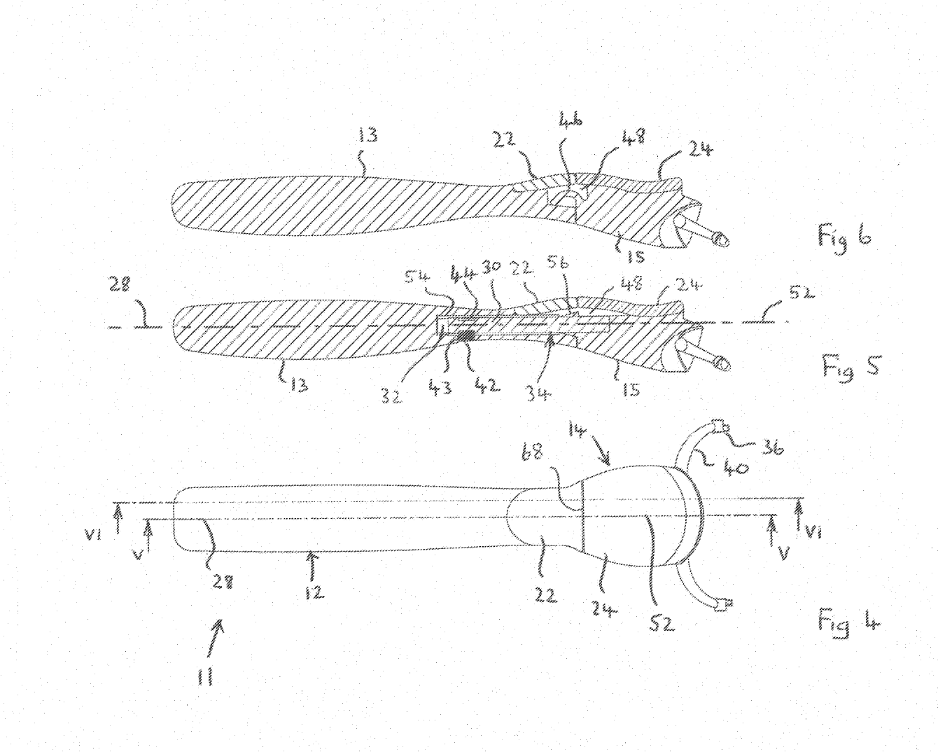

Referring to FIGS. 2 to 6, the second mounting 34 is arranged to permit pivotal movement of the head part 14 about a second axis 52 as, which in this example is substantially aligned along the longitudinal body axis 28.

The second mounting 34 includes a mounting member in the form of a stub axle 30, which projects from the main head part 15, and is receivable within an axle passage 32 defined by the main body part 13. In the example shown, the main body part 13 includes a reinforcing tube 54 which defines the axle passage 32. The stub axle 30 defines a recess 44 which extends around the axle 30 and is located towards but spaced from the remote end of the axle 30. The stub axle 30 includes a conical part 56 which is located just outside the axle passage 32. The conical part 56 aids assembly of the head part 14 to the body 12 as it aids accurate alignment of the recess 44 with the pin hole 43.

The body 12 includes means for retaining the stub axle 30 in the form of a pin 42 which is located in a hole 43 defined by the main body part 13 which extends to meet the axle passage 32. The handle 11 is arranged so that the pin 42 is received within the recess of the axle 30, permitting rotation of the axle 30, but preventing withdrawal of the axle 30 from the axle passage 32.

The main body part 13, the main head part 15, the body cover 22 and the head cover 24 together define a cavity 48.

The second mounting 34 includes biasing means including a pair of resiliently deformable members in the form of fingers 46, which extend within the cavity 48 from the main head part 15 towards the main body part 13, one on either side of the axle 30. Each of the fingers 46 is in the form of a curve, and is formed of a resiliently deformable material, such as a plastics material, rubber or spring steel.

In use, the handle 11 is assembled with the covers 22, 24 in position, and the blade holder 16 with blades 18 clipped into position on the first mounting 20. Initially, with no force applied to the blade holder 16 or head part 14, the head part 14 is biased by the fingers 46 to a neutral condition, as shown in FIGS. 1 to 6. In the neutral condition, the fingers 46 are in a relaxed condition. The fingers 46 contact but are not bonded or fixed to the main body part 13, and thus can move relative to the main body part 13.

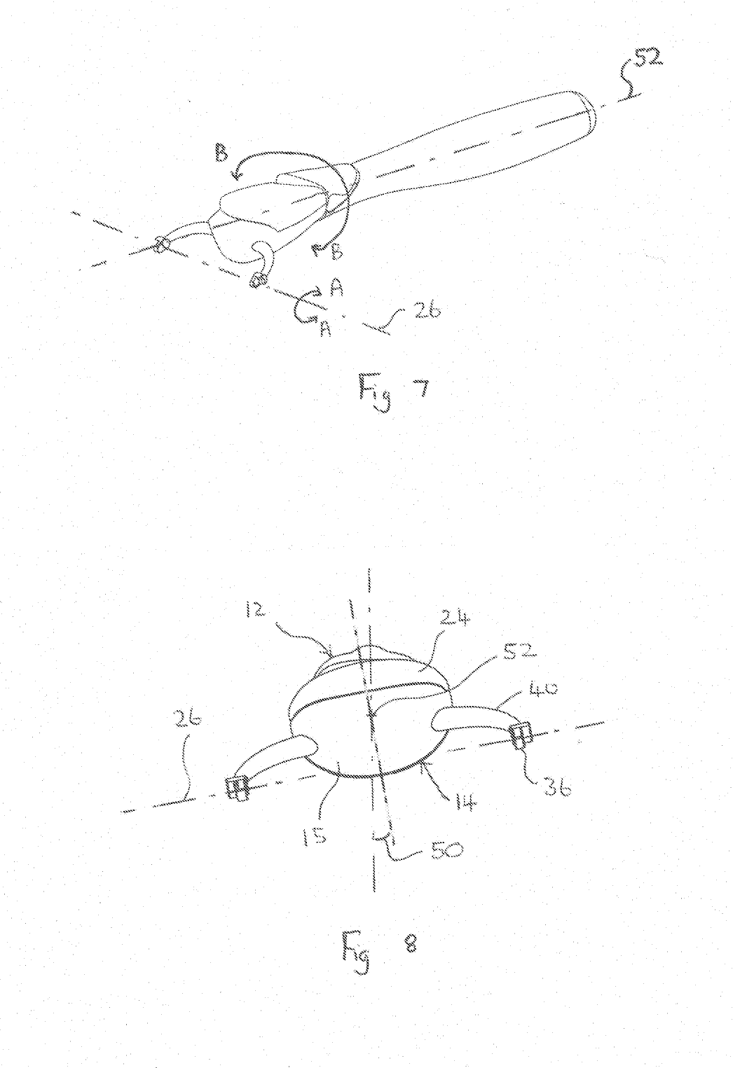

As the blade holder 16 and blades 18 are brought into contact with and moved over the user's skin, varying forces are applied to the blade holder 16 against the force applied by the user through handle 11. The blade holder 16 can move both pivotally around the first axis 26 and pivotally around the second axis 52, these movements being indicated by arrows A and B respectively in FIG. 7. These movements permit accommodation of contours in the surface of the user's skin, meaning that the shaving experience is more pleasant and comfortable for the user.

The forces applied to the blade holder 16 act to move the head part 14 relative to the body 12 rotationally in either a clockwise or an anti clockwise direction, which deforms one of the fingers 46. As the respective finger 46 is increasingly deformed, it provides an increasing resistance force to further deformation, until the applied force and the resistance force are in balance, and the deformation stops, or until no further deformation of the finger can occur because the fingers 46 are jamming further relative movement of the head part 14 and the body 12. As the applied force reduces, the resilient property of the finger 46 biases the head part 14 back to the neutral condition. The fingers 46 thus provide limits to limit the pivotal movement of the head part 14 relatively to the body 12.

The maximum amount of rotational movement permitted, which is shown in FIG. 8 by an angle with reference numeral 50, could be between 5 and 45°, and could be between 5° and 20°, and optimally could be approximately 13-14°.

The rotational movement is also guided by abutting edges 68 of the main head part 15, the main body part 13, the head cover 24 and the body cover 22, which thus comprise a guide.

FIGS. 9 to 34 show other embodiments of the invention, many features of which are similar to those already described in relation to the embodiment of FIGS. 1 to 8. Where features are the same or similar, the same reference numerals have been used and the features will not be described again for the sake of brevity.

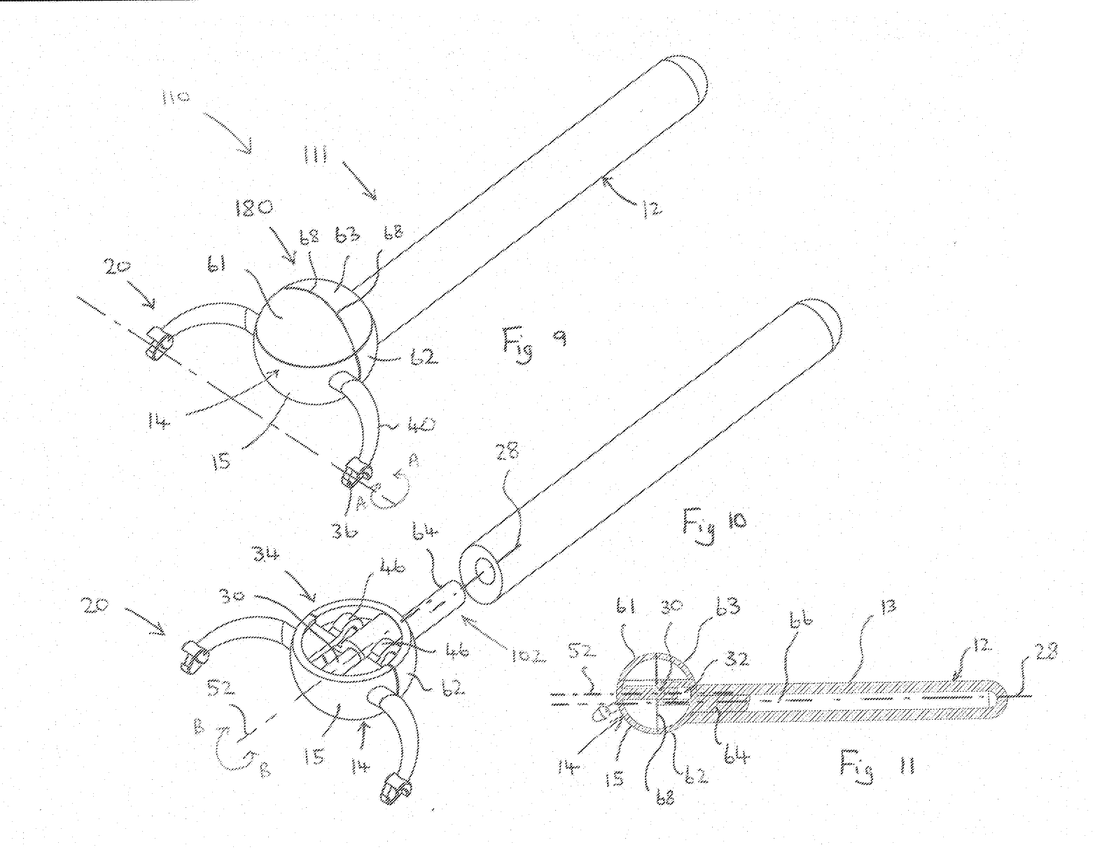

FIGS. 9 to 11 show a second handle 111 for a shaving razor which includes a body 12 and a head 180. The head 180 includes a fixed part 62 which is fixed relative to the body 12 and a pivotable head part 14. The fixed part 62 includes a cover 63 which has been removed in FIG. 10. The pivotable head part 14 includes a main head part 15 and a cover 61 which has been removed in FIG. 10.

The fixed part 62 includes a fixing projection 64 which projects from the fixed part 63 and is received within a fixing passage 66 defined by the body 12. The fixing projection 64 could be bonded in position within the fixing passage 66 by any suitable means, such as with adhesive, or by welding.

As in the previous embodiment, the handle 111 includes a first mounting 20 for mounting a blade holder 16 to the head part 14, and a second mounting 34 for mounting the head part 14 to the body 12, but in this embodiment the head part 14 is indirectly mounted to the body 12 via the fixed head part 62.

The second mounting 34 is similar to that described previously, comprising a stub axle 30, which projects from the main head part 15, and is receivable within an axle passage 32 defined by the fixed head part 62. However, in this embodiment, the axis of the axle passage 32 and hence the second axis 52, which is the axis of rotation of the head part 14, is offset from and parallel to the longitudinal axis 28 of the body 12.

In this embodiment, the second mounting 34 includes biasing means including a pair of resiliently deformable members in the form of fingers 46, which are similar to those previously described, which extend from the main head part 15 to the fixed head part 62, one on either side of the axle 30, and function in a similar way to that previously described.

In use, the handle is used and functions in a similar way to that previously described.

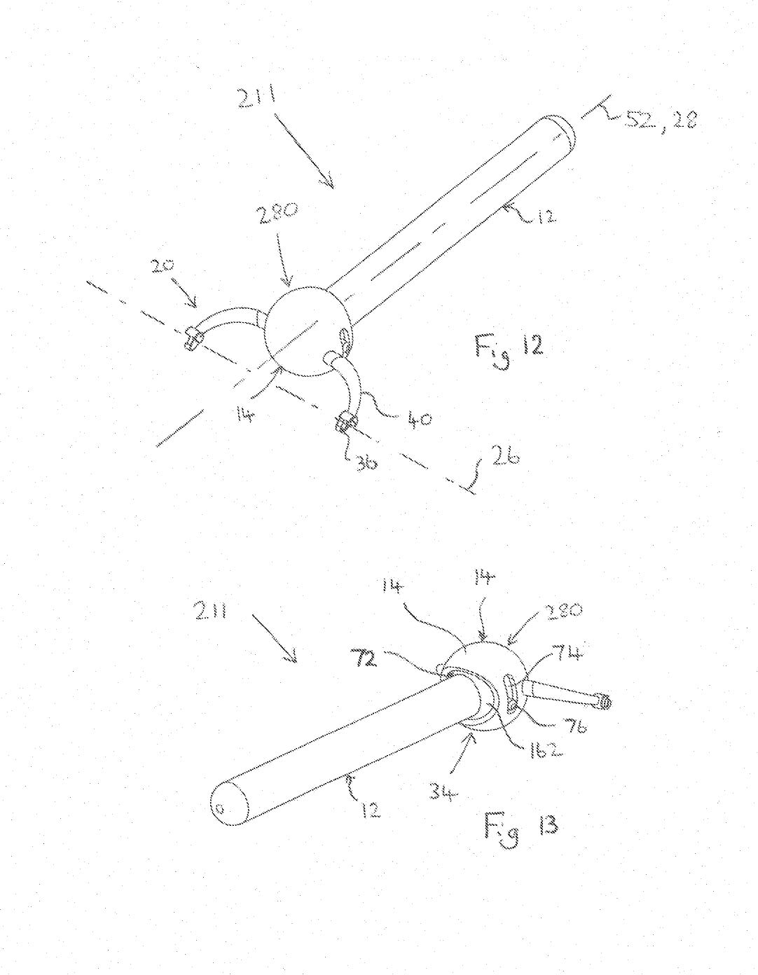

FIGS. 12 and 13 show a third handle 211, which includes a body 12 and a head 280. The head 280 includes a fixed part 162 in the form of a ball which is fixed to the body 12 and a movable head part 14 which defines a socket cavity 162 in which the fixed part 162 is located. The handle 211 includes a guide which includes, in this example, a guide pin 76, which projects from the fixed part 162 into a guide slot 74 defined by the head part 14 to guide and limit movement of the head part 14 relative to the fixed part 162. The pin 76 and slot 74 thus provide limits for movement of the head part 14 relative to the fixed part 162 and the body 12. The slot 74 is arranged to permit only pivotal movement of the head part 14 around the second axis 52, which is aligned along the longitudinal axis 28 of the body 12.

The pin 76 could be formed of a resiliently deformable material to provide biasing means to bias the head 280 to a neutral position.

In use, the handle 211 functions in a similar way to the previous embodiments.

FIGS. 14 to 16 show a fourth handle 311, in which the second mounting 34 includes a mounting member in the form of a torsion pin 82 which replaces the stub axle 30 of FIGS. 1 to 8. The torsion pin 82 is received within a body passage 90 defined by the body 12 and a head passage 92 defined by the head part 14. The torsion pin 82 is formed of a resiliently deformable material, such as a plastics material or rubber. In one example, the plastics material could be a thermoplastic elastomer (TPE). Fixings 88 fix the ends of the torsion pin 82 to the head part 14 and the main body part 13. The fixings 88 could be, for example, formed of adhesive, or by welding, or by any other convenient method.

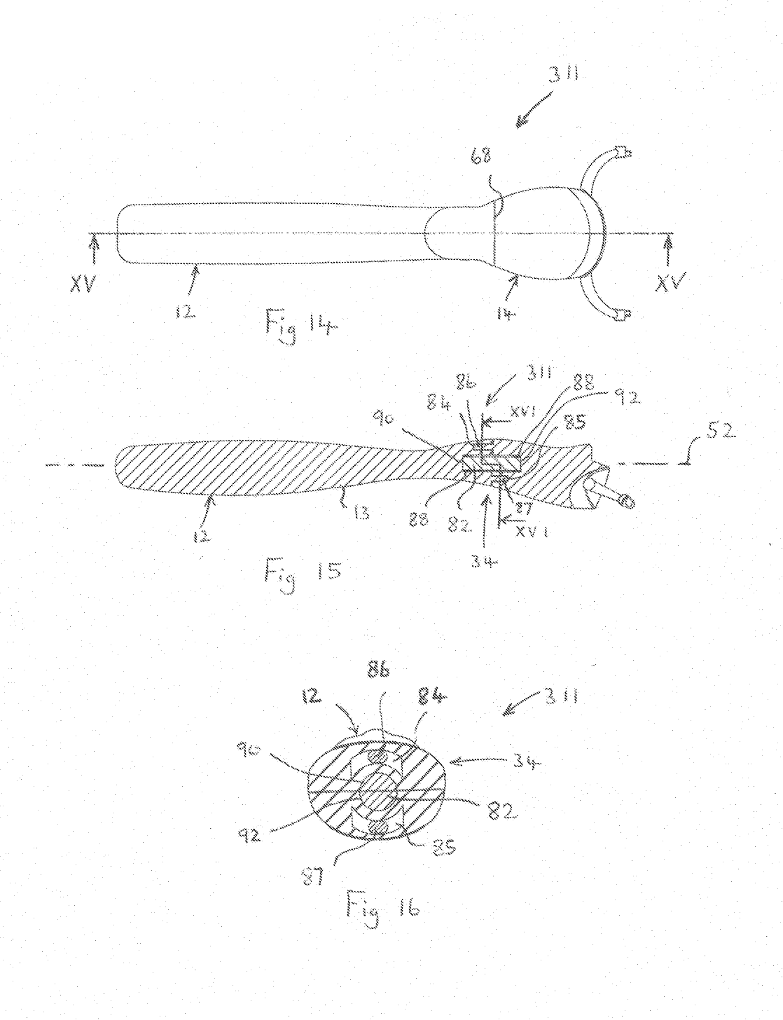

The handle 311 includes a guide which includes, in this example, a pair of guide pins 86, 87, which extend between the head part 14 and the main body part 13. In the example shown, one pin 86 extends from the head part 14 and is received within a guide recess 84 defined by the main body part 13, and another pin 87 extends from the main body part 13 and is received within a guide recess 87 defined by the head part 14. As shown in FIG. 16, each of the recesses 84, 85 is in the shape of an arc extending around the second axis 52. The guide pins 86, 87 and recesses 84, 85 provide limits in that the recesses 84, 85 define the limits of rotational movement of the head part 14 relative to the body 12 around the second axis 52.

In use, the engagement of the guide pins 86, 87 within the recesses 84, 85 permits the head part 14 to only move in a relative rotational, pivotal movement about the second axis 52. Initially, the head part 14 is in a neutral condition. As the head part 14 encounters twisting forces, it moves rotationally around the second axis 52 relative to the body 12, deforming the torsion pin 82. The resilient property of the torsion pin 82 permits deformation until the reactive, resistance forces in the torsion pin 82 are equal to the twisting forces being applied to the head part 14, or until the guide pins 86, 87 are prevented from further movement by the walls of the recesses 84, 85. When the twisting forces are removed, the resilient property of the torsion pin 82 biases the head part 14 back to the neutral position. The torsion pin 82 thus provides biasing means which bias the head part 14 to the neutral condition.

FIGS. 17 and 18 show a fifth handle 411 for a shaving razor which includes a body 12 and a head 480, which is similar to the second handle shown in FIGS. 9 to 11 and described above. In this embodiment, however, the mounting member is in the form of a torsion member in the form of a pin 82 which replaces the stub axle 30, and extends between the main head part 15 and the fixed head part 62. At one end, the torsion pin 82 is received and fixed within a recess 96 defined by a retaining formation 94 of the main head part 15 and at the other end the torsion pin is received and fixed within the axle passage 32 defined by the fixed head part 62.

The torsion pin 82 is formed of a resiliently deformable material, such as a plastics material or rubber. In one example, the plastics material could be a thermoplastic elastomer (TPE).

In use, the handle 411 is used and functions in a similar way to that previously described. The resilient property of the torsion pin 82 permits deformation until the reactive, resistance forces in the torsion pin 82 are equal to the twisting forces being applied to the head part 14. When the twisting forces are removed, the resilient property of the torsion pin 82 biases the head part 14 back to the neutral position. The torsion pin 82 thus provides biasing means which bias the head part 14 to the neutral condition.

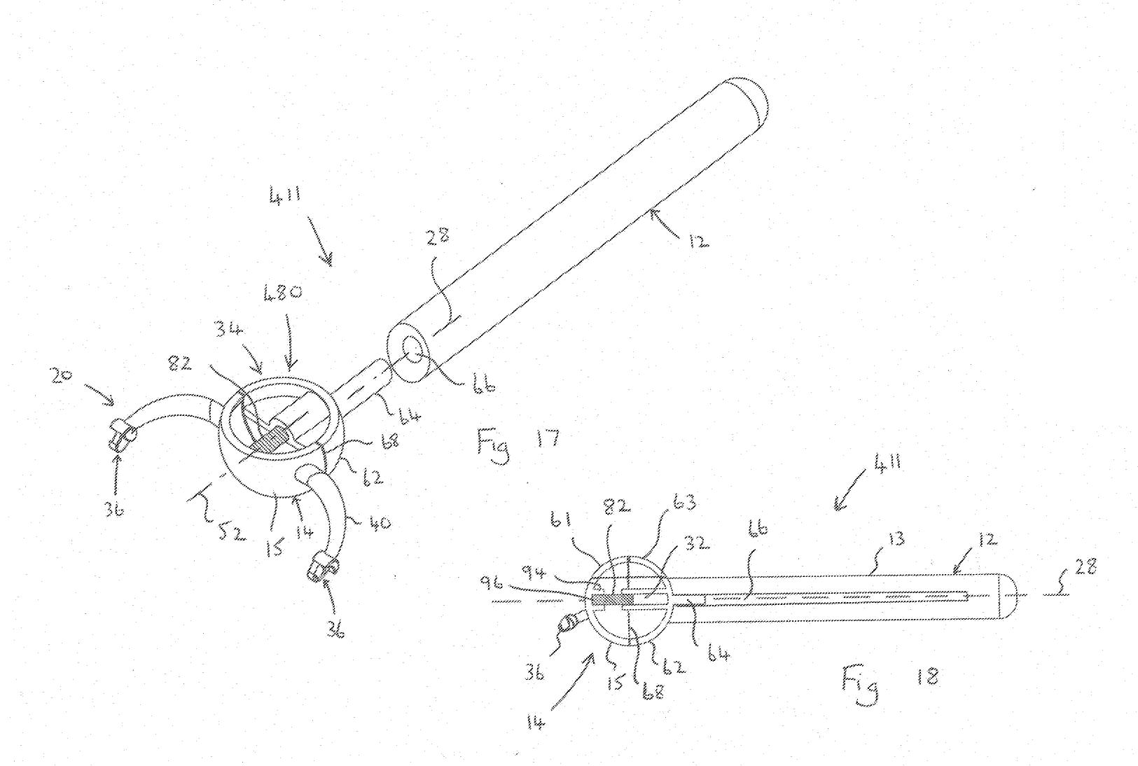

FIGS. 19 to 21 show a sixth handle 511, in which the second mounting 34 includes a mounting member in the form of a stub axle 30 which projects from the main head part 15, and is receivable within an axle passage 32 defined by the main body part 13.

The main body part 13 defines a recess 100 which abuts the head part 14 and is substantially filled with a torsion member 98 in the form of a sleeve. The torsion sleeve 98 is formed of a resiliently deformable material, such as a plastics material or rubber. In one example, the plastics material could be a thermoplastic elastomer (TPE). Fixings 88 fix the ends of the torsion sleeve 98 to the head part 14 and the main body part 13. The fixings 88 could be, for example, formed of adhesive, or by welding, or by any other convenient method.

In use, the handle 511 is used and functions in a similar way to that previously described. The resilient property of the torsion sleeve 98 permits deformation until the reactive, resistance forces in the torsion sleeve 98 are equal to the twisting forces being applied to the head part 14. When the twisting forces are removed, the resilient property of the torsion sleeve 98 biases the head part 14 back to the neutral position. The torsion sleeve 98 thus provides biasing means which bias the head part 14 to the neutral condition.

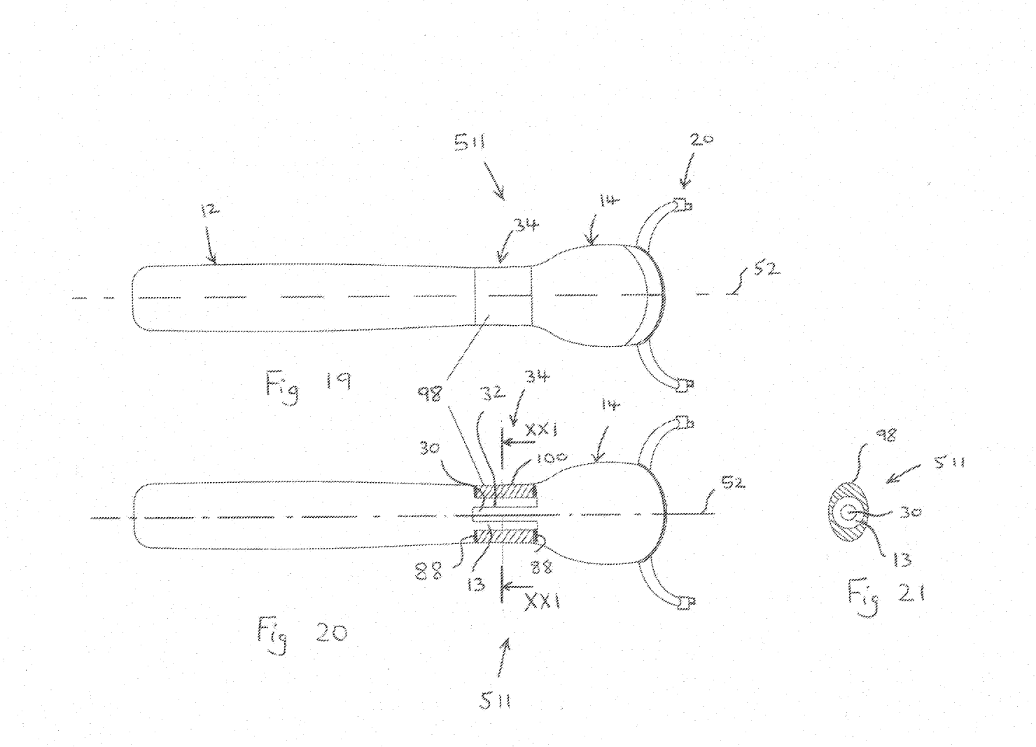

The first mounting 20 could be different to the arrangements shown in the drawings. FIG. 22 shows part of a seventh razor 610, which is similar to the first razor 10 shown in FIG. 1, but has a different first mounting 20, only part of which is shown in FIG. 22. The first mounting 20 in FIG. 20 comprises a recess 21 defined by the head part 14 in which a projection (not shown) associated with a blade holder and/or a blade (not shown) is receivable. Other types and forms of first mounting 20 could be suitable. In some examples the first mounting 20 could fix the orientation of the blade holder and/or the blade relative to the head part, while in others, as described above the first mounting may permit movement of the blade holder and/or the blade relative to the head part.

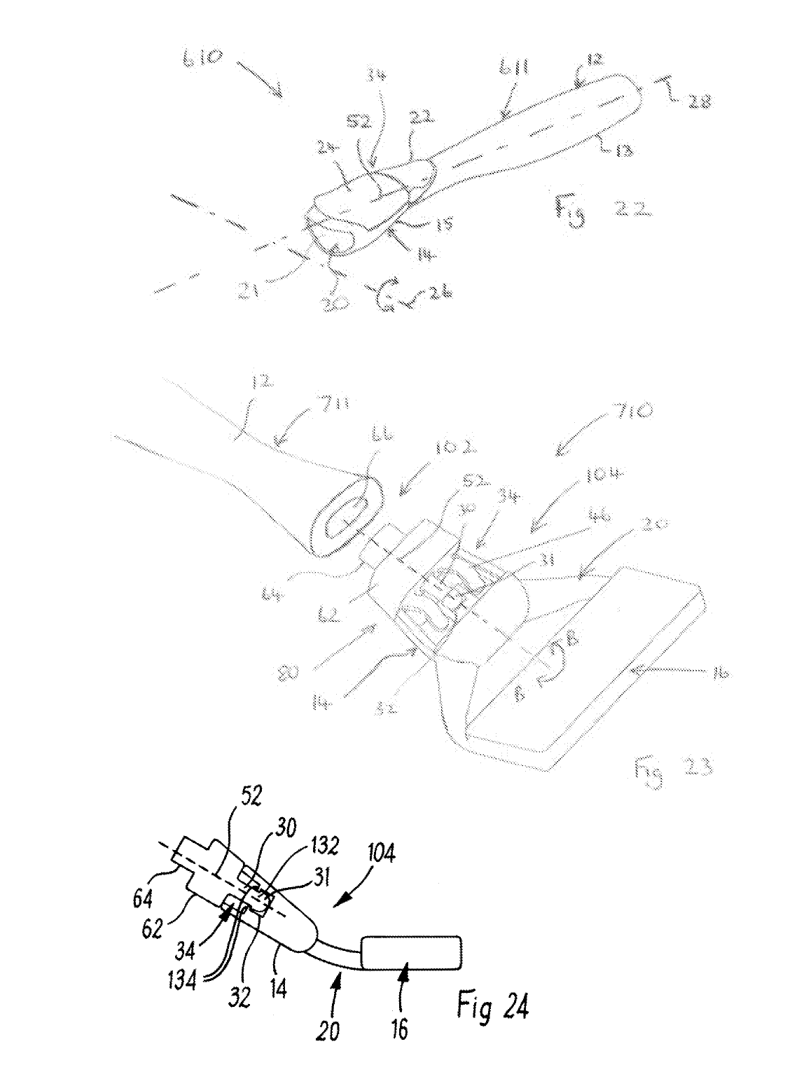

FIGS. 23 and 24 show an eighth razor 710 which is somewhat similar to the second razor 111 shown in FIGS. 9 to 11. The eighth razor 710 comprises a handle 711 and a disposable, detachable head assembly 104, the head assembly 104 comprising a head 80, a blade holder 16 and a first mounting 20 for mounting the blade holder 16 to the head 80. The handle 711 comprises a body 12.

The razor 710 includes a third mounting for detachably mounting the head assembly 104 to the handle 711.

The head 80 comprises a head part 14 and a fixed head part 62, and the second mounting 34 mounts the head part 14 to the fixed head part 62 so that detachment of the head part 14 from the fixed head part 62 is substantially prevented.

In this example, the second mounting 34 includes a stub axle 30 with an enlarged end 31 in the form of a domed mushroom which projects from the fixed head part 62. The enlarged end 31 is received and held captive within a cavity 32 defined by the head part 14 which has a relatively narrow mouth 132 defined by lips 134. The lips 134 permit the enlarged end 31 to be pushed therethrough, but resist or substantially prevent disengagement of the fixed head part 62 and the head part 14. This arrangement permits rotational movement of the head part 14 around the second axis 52 as indicated by arrows B, but resists other movement such as lateral pivotal movement.

The third mounting 102 comprises a fixing projection 64 which projects from the fixed part 62 and is received within a fixing passage 66 defined by the handle 711. The fixing projection 64 is a push fit or a click fit within the passage 66 to permit attachment and detachment of the head assembly 104 from the handle 711. The third mounting 102 is arranged so that the orientation of the fixed head part 62 is fixed relative to the body 12 of the handle 711.

As in previous embodiments, the second mounting 34 includes biasing means including a pair of resiliently deformable fingers 46 which bias the head part 14 to a neutral condition, and in use operation is similar to that described above. However, in this embodiment, the head assembly 104 is supplied to the user as an integral unit which is detachable from the handle 711 to permit replacement.

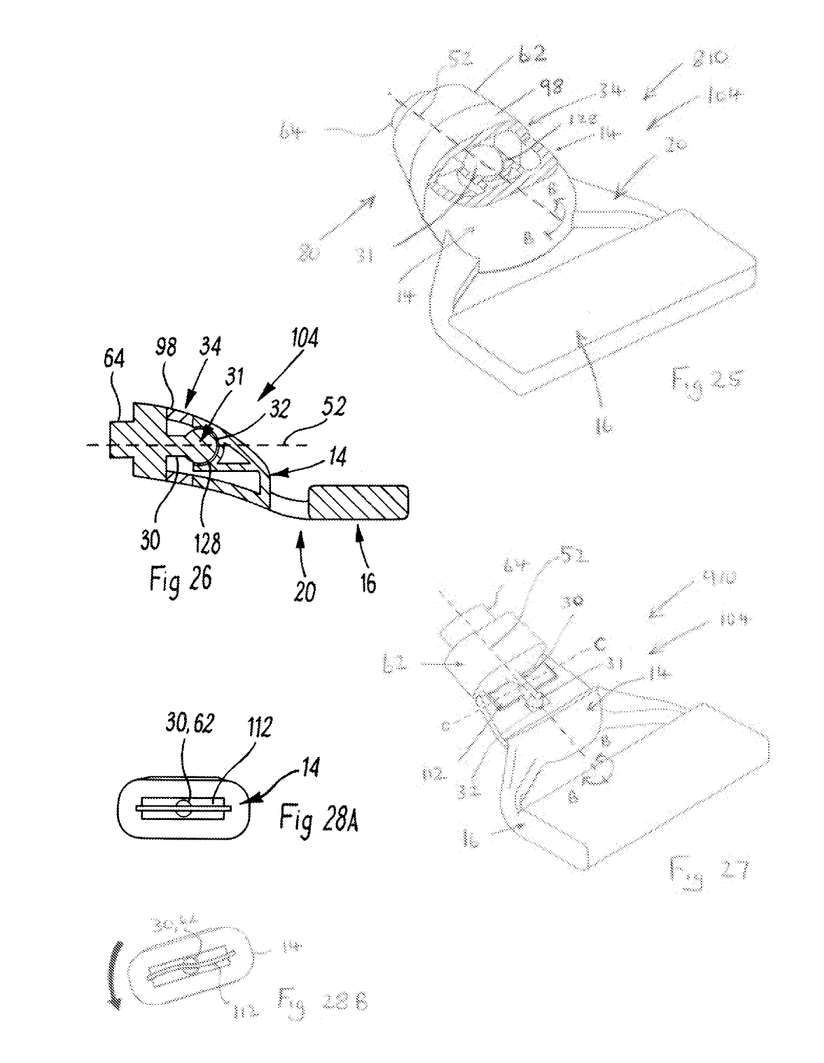

FIGS. 25 and 26 show a ninth razor 810 which is similar to the eighth razor 710, except that the biasing means is provided by a resiliently deformable torsion member in the form of a collar 98 which extends between the head part 14 and the fixed head part 62.

In contrast to the previous embodiment, the enlarged end 31 is in the form of a ball and is received within a cavity 32 defined by a socket formation 128 which comprises part of the head part 14. The collar 98 permits a degree of rotational movement of the head part 14 relative to the fixed head part 62 around the second axis 52 as indicated by arrows B, but resists other movement such as lateral pivotal movement.

Advantageously, torsion members such as the collar 98, the pin 82 and the sleeve 98 are deformed by torsion, so that the deformation (and hence increase in resistance to the turning force) of the resiliently deformable member is directly proportional to the amount of rotational movement of the blade holder and/or the blade away from the neutral condition. The torsion members are simple and resistant to corrosion.

FIGS. 27 and 28 show a tenth razor 910 which is similar to the eighth razor 710 and the ninth razor 810, except that the biasing means is provided by a resiliently deformable spring member 112 (which could be formed of spring steel) which extends between the head part 14 and the fixed head part 62. FIG. 28A shows the head part 14 in the neutral condition, in which the spring member 112 is in a relaxed condition. FIG. 28B shows the head part 14 moved away from the neutral condition, in which the spring member 112 is in a deformed condition, biasing the head part 14 back to the neutral condition.

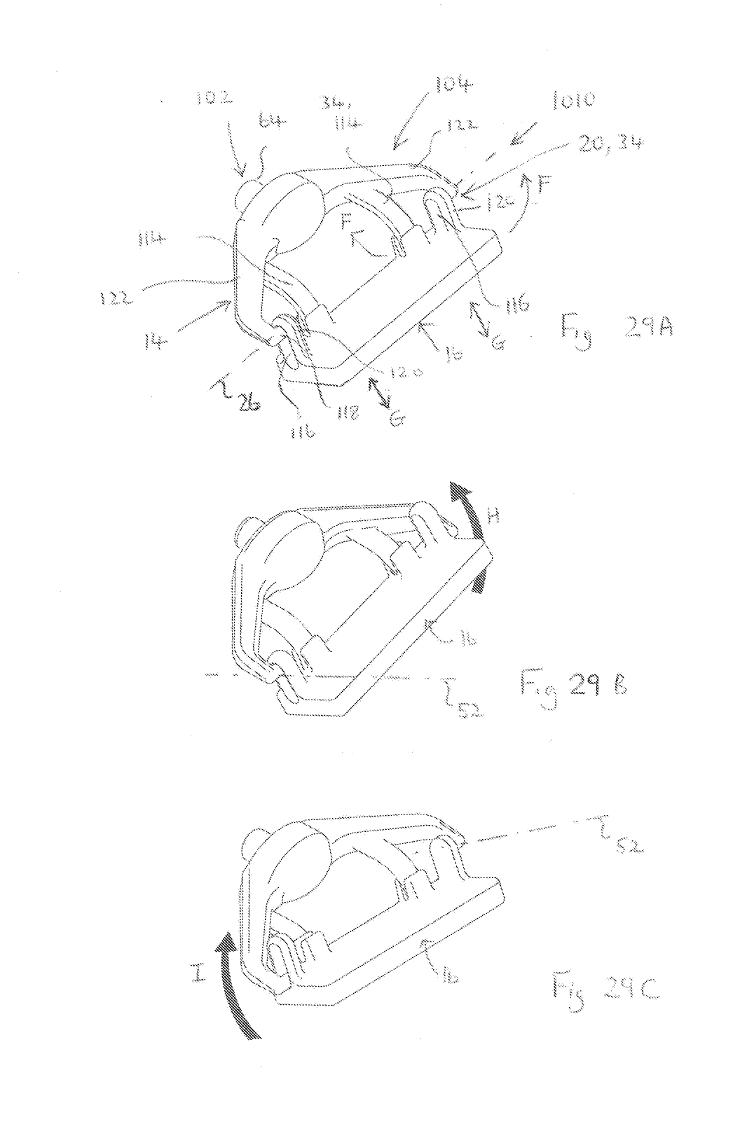

FIGS. 29A to 29C show an eleventh razor 1010 comprising a head assembly 104 including a head part 14 and a blade holder 16. A pair of spaced projections 120 extend, one from each end of the blade holder 16, each defining a slot 116. The head part 14 includes a pair of yoke arms 122 each including an inwardly directed lug 118, each lug 118 being received within one of the slots 116. A pair of resiliently deformable members 114 extend between the arms 122 and the blade holder 16, biasing the blade holder 16 away from the head part 14, so that in a neutral condition, the lugs 118 are both located at an end of the respective slot 116 furthest away from the blade holder 16.

In use, the blade holder 16 can move rotationally around a first axis 26 as indicated by arrows F in FIG. 29A in which neither of the lugs 118 moves relatively along the slots 116; in a parallel motion in which both lugs 118 move together along the slots 116 as indicated by arrows G in FIG. 29A; and rotationally about a second axis 52 as indicated by arrows H and I in FIGS. 29B and 29C in which one of the lugs 118 moves more than the other along the slots 116. The resiliently deformable members 114 increasingly resist the relative movement of the blade holder 16, but permit accommodation of the varying pressures during shaving.

In this example, the lugs 118, slots 116, projections 120 and resiliently deformable members 114 provide both the first and second mountings.

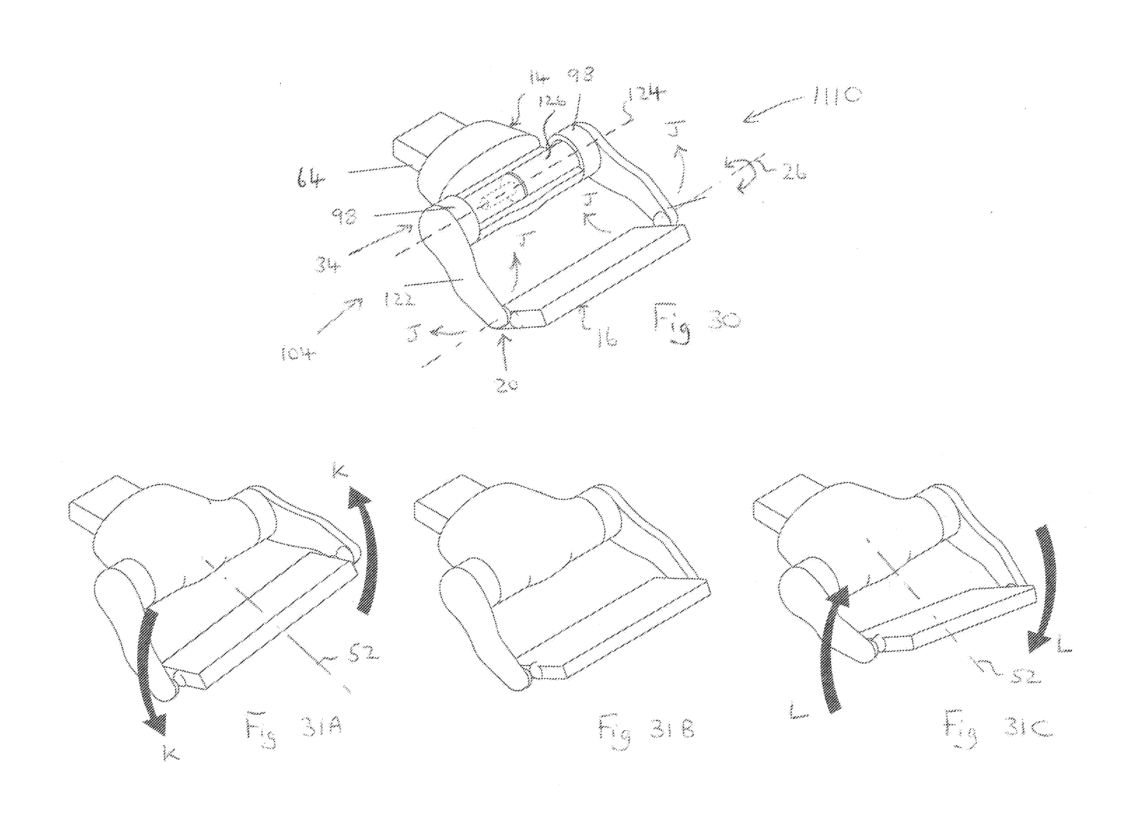

FIGS. 30 and 31 show a twelfth razor 1110 comprising a head assembly 104 including a head part 14 and a blade holder 16. A second mounting 34 mounts a pair of spaced arms 122 to the head part 14. The second mounting 34 includes a split axle 126 which permits independent pivoting of each of the arms 122 about a third axis 124. The second mounting includes a pair of resiliently deformable torsion members 98 in the form of collars which each bias one of the arms 122 to a neutral condition.

A first mounting 20 mounts the blade holder 16 to the arms 122 permitting pivoting of the blade holder 16 relative to the arms 122 about a first axis 26. The third axis 124 could be parallel to the first axis 26.

FIGS. 30 and 31B show the blade holder 16 in the neutral condition. In use, the blade holder 16 can move rotationally around a first axis 26 as indicated by arrows J in FIG. 30 in which neither of the arms 122 moves; in a parallel motion rotationally around the third axis 124 in which both of the arms 122 move; and rotationally about the second axis 52 as indicated by arrows K and L in FIGS. 31A and 31C in which the arms 122 move in opposite directions.

The torsion members 98 increasingly resist the relative movement of the arms 122, but permit accommodation of the varying pressures during shaving.

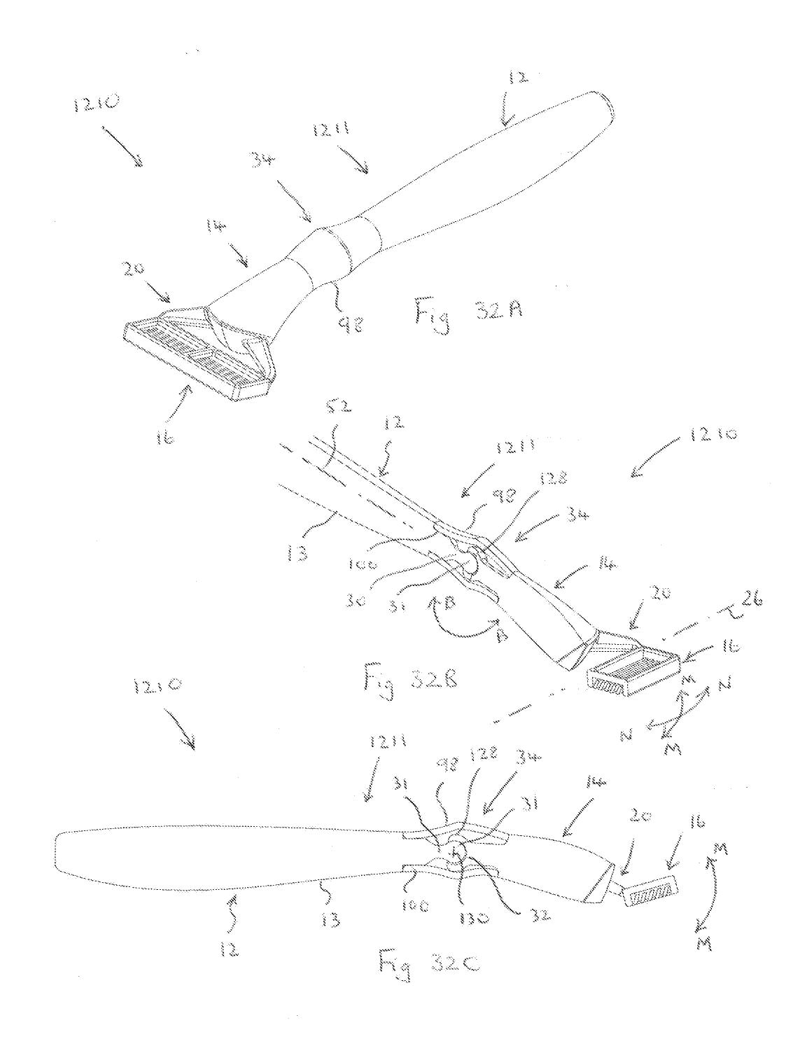

FIGS. 32A to 32C show a thirteenth razor 1210, which is somewhat similar to the arrangement of the ninth razor 810, but with some important differences. The thirteenth razor 1210 includes a handle 1211 including a body 12 and a head part 14 mounted to the body 12 by a second mounting 34.

The second mounting 34 includes a mounting member in the form of a stub axle 30 having an enlarged end 31 in the form of a ball, which is received within a cavity 32 defined by a socket formation 128 which comprises part of the head part 14.

The main body part 13 and the head part 14 define a recess 100 in which is received a torsion member 98 in the form of a sleeve. The sleeve 98 extends substantially over the length of the stub axle 31 and the socket formation 128. The greater length of the sleeve 98 in comparison to, for example, the collar 98 of the ninth razor 810 shown in FIGS. 25 and 26 permits a greater variety of movement of the head part 14 relative to the body 12. For example, in this embodiment, the head part 14 can (as in previous embodiments) pivotally rotate relative to the body 12 around the second axis 52, but the sleeve 98 also permits an amount of pivotal lateral movement of the head part 14 in any direction around the centre 130 of the ball shaped enlarged end 31. In FIGS. 32B and 32C, examples of this movement are represented by arrows M and N. Thus, in this embodiment, the second mounting is arranged to permit lateral movement of the head part 14 relative to the body 12 in any radial direction relative to the second axis 52. The applicant has found that, advantageously, this arrangement permits the razor 1210 to be provided with a first mounting 20 which is fixed.

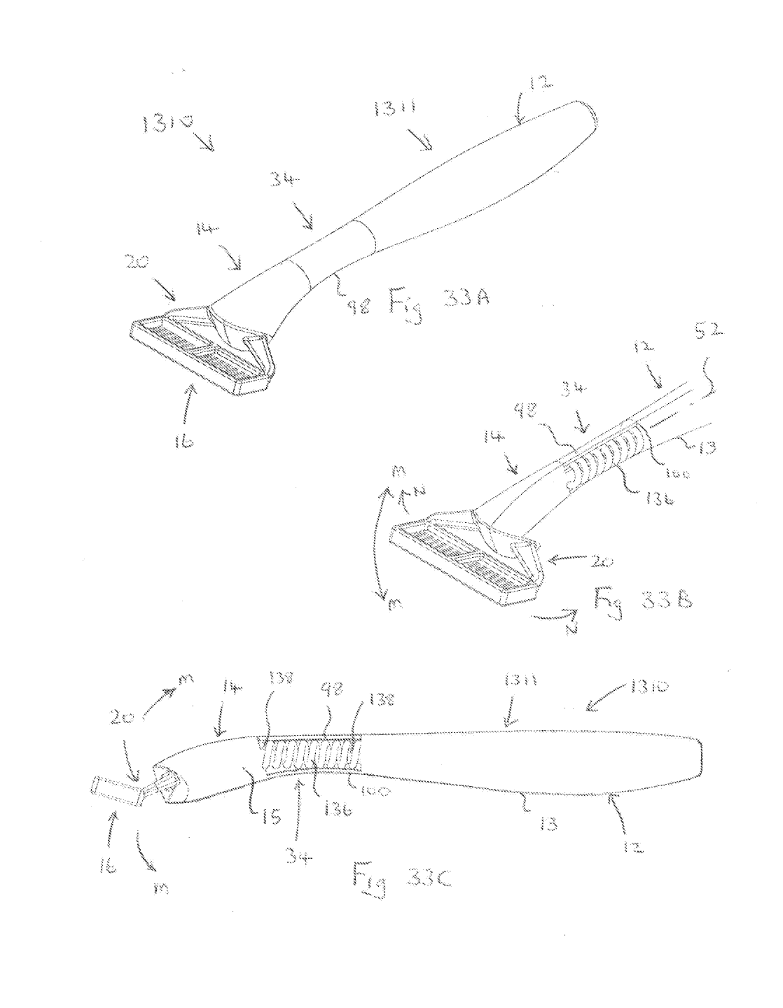

FIGS. 33A to 33C show a fourteenth razor 1310, which is somewhat similar to the arrangement of the twelfth razor 1210, except that the second mounting 34 comprises a spring 136 rather than a ball and socket formation. The second mounting 34 includes mounting projections 138 which extend from the main head part 15 and the main body part 13, to which the spring 136 is mounted. As in the previous embodiment, the head part 14 can pivotally rotate relative to the body 12 around the second axis 52, and can pivot laterally in any direction, the spring 136 permitting a bend to form in the handle 1311 between the head part 14 and the body 12. In one example, the spring 136 could be formed of spring steel. Thus, again, the second mounting is arranged to permit lateral movement of the head part 14 relative to the body 12 in any radial direction relative to the second axis 52.

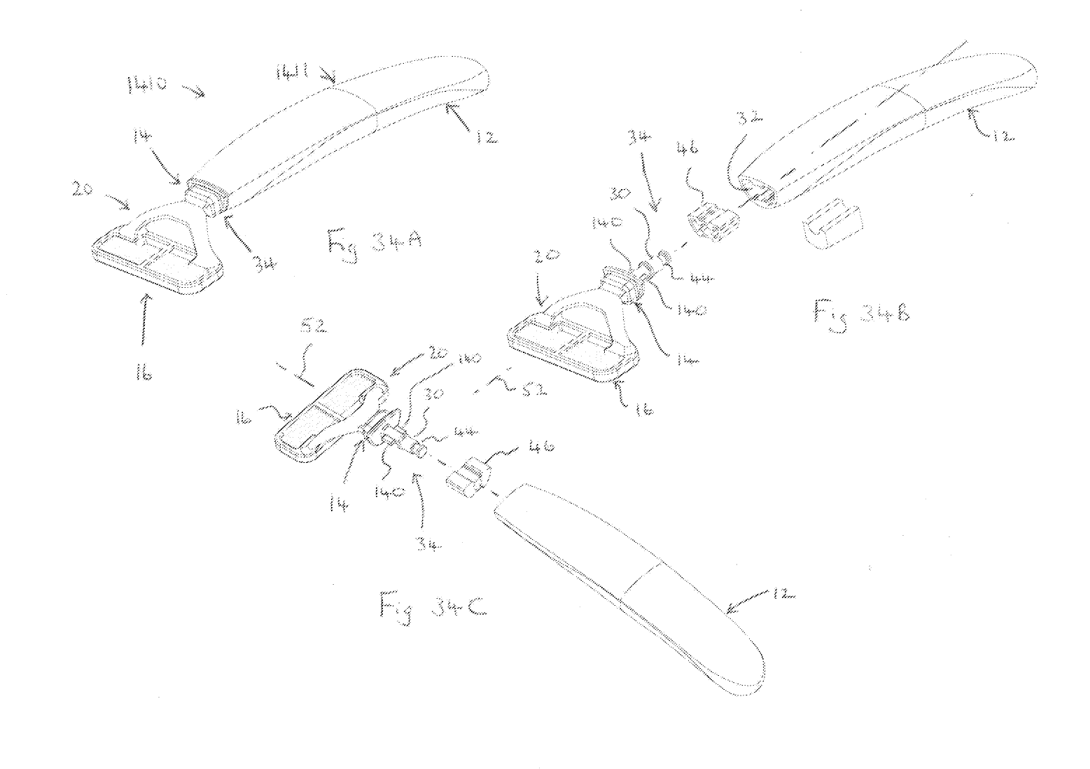

FIGS. 34A to 34C show a fifteenth razor 1410, which is somewhat similar to the arrangement of the tenth razor 910 shown in FIGS. 27 and 28. In this embodiment, the second mounting 34 comprises a stub axle 30 including laterally extending wings 140 which extends along the longitudinal second axis 52 from the head part 14 and is received within a resiliently deformable biasing member 46 located within the cavity 32 defined by the body 12. As the head part 14 pivots around the second axis 52, the wings 140 deform the biasing member 46, which progressively resists the deformation, and when the user removes the razor from the face, the biasing member 46 returns the head part 14 to the neutral condition.

Various other modifications could be made without departing from the scope of the invention. The handle could be of any suitable size and shape, and could be formed of any suitable material or combination of materials. The mounting formations could be of any suitable size, shape and design, and could be arranged to be compatible with different blade holders from different blade manufacturers. The arrangement of the mounting formations could be different. For example, the mounting formation could be in the form of a clip, or could receive a clip. The mounting formations could be arranged to mount a blade or blades directly, without a holder. The holder could include any suitable number of blades, from one upwards.

The orientation of the rotational axes could be arranged differently. For example, the second axis could be angled obliquely relative to the longitudinal body axis, and could be angled obliquely relative to the first axis.

In another embodiment, the handle could include a first mounting which mounts a blade or a holder without permitting pivotal movement of the blade or holder. In still another embodiment, the first mounting could non removably mount a blade or blade holder to the handle. For example, the first mounting could comprise a simple hinge of a flexible or a resiliently flexible material.

The handle and razor could be suitable for use on human or animal skin.

Any of the features of any of the embodiments shown could be combined in any suitable way, within the scope of the overall disclosure of this document.

There is thus provided a handle for a shaving razor which permits pivotal movement of a blade and blade holder around an axis which is normal to the longitudinal axis of the blade or blades and is generally aligned with a longitudinal axis of the handle. The razor is thus better able to accommodate skin contours, reducing the risk of shaving cuts and razor burn and increasing the comfort of the user.

What is claimed is:

1. A shaving razor, the razor including a handle and a head part, a first mounting for mounting a blade holder and/or a blade to the head part, the handle including a body for gripping by a user in use, the razor including a second mounting, wherein, in use, the blade holder and/or the blade extend lengthwise along a first axis, the second mounting being arranged to permit the blade holder and/or the blade to move pivotally relative to the body around a second axis which is orientated differently to the first axis.

2. The razor according to claim 1, in which the second axis is substantially at 90° to the first axis.

3. The razor according to claim 1, in which the body is elongate and has a longitudinal axis, the head part is elongate and has a longitudinal axis, and the second axis is substantially aligned along or parallel to the body axis and/or the head part axis.

4. The razor according to claim 1, in which the first mounting is arranged to permit pivotal movement of the blade holder or blade about the first axis.

5. The razor according to claim 1, in which the second mounting is arranged to permit pivotal movement of the head part about the second axis.

6. The razor according to claim 1, in which the second mounting includes one or more limits to limit the movement of the blade holder and/or the blade relative to the body.

7. The razor according to claim 1, in which the second mounting includes a guide, which guides movement of the blade holder and/or the blade relative to the body.

8. The razor according to claim 1, in which the second mounting includes biasing means to bias the blade holder and/or the blade to a neutral condition, the biasing means including include one or more resiliently deformable members, which are arranged to resist movement of the blade holder and/or the blade away from the neutral condition.

9. The razor according to claim 1, in which the second mounting includes biasing means to bias the blade holder and/or the blade to a neutral condition, the biasing means including include one or more resiliently deformable members, which are arranged to provide increasing resistance to further movement away from the neutral condition.

10. The razor according to claim 1, in which the second mounting includes biasing means to bias the blade holder and/or the blade to a neutral condition, the biasing means including include one or more resiliently deformable members, the or each resiliently deformable member comprising a finger, a collar, a sleeve or a pin.

11. The razor according to claim 1, in which the head part comprises part of the handle, the first mounting permits attachment and detachment of the blade holder and/or the blade from the head part, and the second mounting mounts the head part to the body so that detachment of the head part from the body is substantially prevented, the second mounting including a mounting member, which extends between the head part and the body, and is receivable within a passage or cavity.

12. The razor according to claim 1, in which the head part comprises part of a head, which also comprises a fixed head part, and the second mounting mounts the head part to the fixed head part so that detachment of the head part from the fixed head part is substantially prevented.

13. The razor according to claim 1, in which the head part comprises part of a head, which also comprises a fixed head part, the second mounting the head part to the fixed head part so that detachment of the head part from the fixed head part is substantially prevented, the razor including a third mounting which mounts the head to the body, the third mounting permitting attachment and detachment of the head from the body and being arranged so that the orientation of the fixed head part is fixed relative to the body.

14. The razor according to claim 1, in which the second mounting is arranged to permit lateral movement of the head part relative to the body in any radial direction relative to the second axis.

15. A method of shaving, the method including providing a shaving razor, the razor including a handle and a head part, a first mounting for mounting a blade holder and/or a blade to the head part, the handle including a body for gripping by a user in use, the razor including a second mounting, wherein, in use, the blade holder and/or the blade extend lengthwise along a first axis, the second mounting being arranged to permit the blade holder and/or the blade to move pivotally relative to the body around a second axis which is orientated differently to the first axis.

16. A shaving razor substantially as hereinbefore described and/or with reference to any of the accompanying drawings.

17. A method of shaving substantially as hereinbefore described and/or with reference to any of the accompanying drawings.
